(19) United States
(12) Patent Application Publication
(10) Pub. No.: US 2026/0258270 A1
(43) Pub. Date: Sep. 3, 2026

(54) Printable Medium, Printed Article, and Related Methods

(71) Applicant: Flexotronix Limited, Brighton & Hove (GB)

(72) Inventor: Robert STEVENS, Brighton & Hove (GB)

(73) Assignee: Flexotronix Limited, Brighton & Hove, ES (GB)

(21) Appl. No.: 19/157,517

(22) PCT Filed: Feb. 27, 2024
(86) PCT No.: PCT/GB2024/050522

§ 371 Date: Aug. 18, 2025

(30) Foreign Application Priority Data
Feb. 27, 2023 (GB) 2302798.0

(51) Int. Cl. C09D 11/52; B41M 1/04; B41M 5/52; C09D 11/037

(52) U.S. Cl. CPC C09D 11/52; B41M 1/04; B41M 5/52; C09D 11/037

(57) ABSTRACT

In one aspect a printable medium is disclosed, comprising flakes and a liquid, wherein the flakes comprise silver, graphene, or a mixture thereof, and have a length of from 0.1 μm to 3 μm, a thickness of 0.8 nm to 100 nm, and an aspect ratio of from 5:1 to 3750:1. In another aspect an article is disclosed comprising a conductive layer, a porous receiving layer, and a base layer, wherein the conductive layer is provided on the porous receiving layer, the porous receiving layer is provided on the base layer, the conductive layer comprises flakes; and the porous receiving layer has a surface roughness of 500 nm or less.

### TECHNICAL FIELD

The present invention relates to printable media, articles including printed articles, and methods for producing the printable media and articles of the invention. The printable media, articles and methods of the present invention can be used to provide a thin, conductive, printed layer.

### BACKGROUND

It is desirable in a great number of applications to print an electrically conductive trace onto a substrate. However, methods of printing conductive material may require the printed article to be heated at high temperature after printing, e.g. order to drive off components of the printing medium which would otherwise reduce the conductivity of the printed layer, and are consequently not suitable for printing onto materials which distort or melt above the heat treatment temperature. Additionally, methods may require a relatively thick layer of conductive material to be printed in order to provide the requisite conductivity. A thick layer of conductive material will result in a printed article which may not be suitable for applications in which a degree of flexibility is required, as flexing of the printed layer could cause discontinuities (e.g. cracks) in the thick layer of conductive material, which could reduce conductivity.

There is therefore a need to provide printable media, articles and methods which can be used to provide a thin, conductive, printed layer, and can be applied to materials with a relatively low tolerance to heat, and which can be used in applications where a degree of flexibility is required in the printed article.

### SUMMARY

In one aspect the present invention provides a printable medium, comprising flakes and a liquid, wherein the flakes comprise silver, graphene, boron nitride, or a mixture thereof, and have a length of from 0.1 μm to 3 μm, a thickness of 0.8 nm to 100 nm, and an aspect ratio of from 5:1 to 3750:1.

In another aspect the present invention provides an article comprising a conductive layer, a porous receiving layer, and a base layer, wherein the conductive layer is provided on the porous receiving layer, the porous receiving layer is provided on the base layer, the conductive layer comprises flakes as defined herein in connection with the printable medium of the present invention; and the porous receiving layer has a surface roughness of 500 nm or less.

In another aspect the present invention provides a method of producing a printable medium as defined in claim 1, comprising providing flakes as defined herein in connection with the printable medium of the present invention, providing a liquid as defined herein in connection with the printable medium of the present invention, and mixing the flakes and the liquid.

In another aspect, the present invention provides a method of printing comprising providing a printable medium of the present invention, providing a substrate, and applying the printable medium to the substrate, wherein the substrate comprises a porous receiving layer provided on a base layer, and the porous receiving layer is as defined herein in connection with the article of the present invention.

### BRIEF DESCRIPTION OF THE FIGURES

FIG. 1 depicts silver flakes suitable as the flakes in the printable medium of the present invention.

FIG. 2 is a cross-section view of a printed article according to the present invention.

FIG. 3 is a surface view of a printed article according to the present invention.

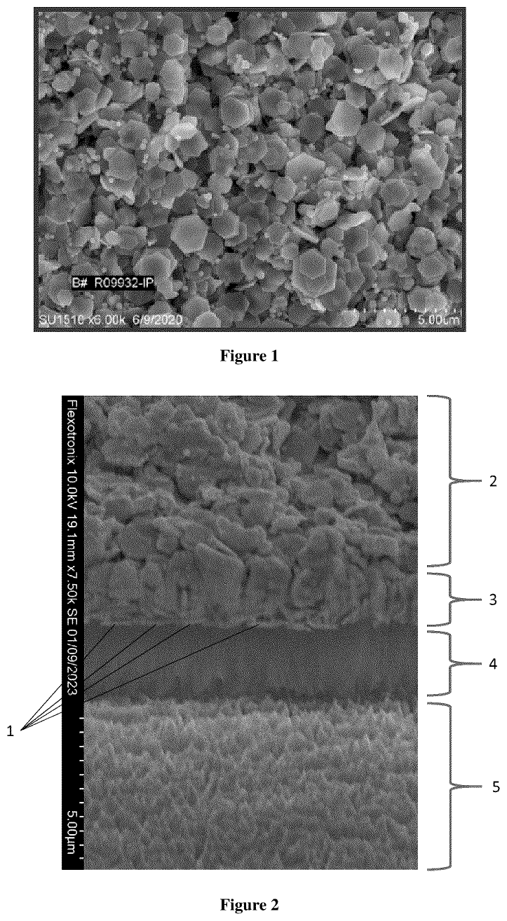

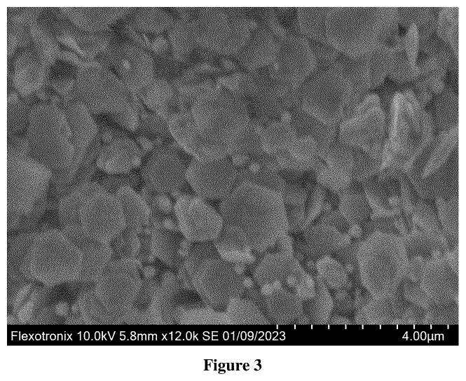

### DETAILED DESCRIPTION

The printable medium of the present invention comprises flakes. The term flake will be understood by one of skill in the art and refers to a particle with a flake-like geometric shape. Thus, a flake will typically have a three dimensional shape whereby its length is significantly greater than its thickness. As used herein the length of a flake typically refers to the largest size of the flake in a major dimension, and the thickness of a flake typically refers to the largest size of the flake in a minor dimension.

As used herein the major dimension of a flake is typically the dimension in which the flake is largest. As used herein, the minor dimension is typically the dimension in which the flake is smallest. The major dimension may be substantially perpendicular to the minor dimension (e.g. there may be an angle of approximately 90° between the major dimension and the minor dimension, such as for example an angle in the range of 80° to 100°, or an angle in the range of 85° to 95°).

As used herein the aspect ratio of a flake is typically the ratio of the length of a flake to the thickness of that flake.

The length of the flakes of the printable medium of the present invention may refer to the number median (D50) of the particle sizes, for the greatest extent of each particle in the major dimension. The thickness of the flakes of the printable medium of the present invention may refer to the number median (T50) of the particle sizes, for the greatest extent of each particle in the minor dimension.

The aspect ratio of the flakes of the printable medium of the present invention can be calculated as the arithmetic mean of the aspect ratios of flakes in the printable medium.

The number median particle size of flakes in both the major dimension (length) (D50) and minor dimension (thickness) (T50) can be determined by imaging the flakes, e.g. by SEM microscopy, and determining the number median of the size in question. The arithmetic mean of the aspect ratios of flakes can be determined by imaging the flakes, e.g. by SEM microscopy, and determining the arithmetic mean of the aspect ratios of the flakes. For example, the length and thickness can determined by obtaining a suitable image using an appropriate imaging technique. From this image, a sample (n) of random individual flakes (e.g., n=100) can be examined and the greatest size of the individual flakes in each of the major and minor dimensions can be measured and recorded. The D50 of the greatest extent in the major dimension (for length) and the T50 of the greatest extent in the minor dimension (for thickness), as well as the aspect ratio of each flake and subsequently the arithmetic mean aspect ratio of the flakes, can be calculated from the data thus obtained from the sample.

The flakes of the printable medium of the present invention have a length of from 0.10 μm or more, such as for example 0.20 μm or more, 0.30 μm or more, 0.40 μm or more, 0.50 μm or more, 0.60 μm or more, 0.70 μm or more, 0.80 μm or more, or 0.90 μm or more.

The flakes of the printable medium of the present invention have a length of from 3.00 μm or less, such as for example 2.50 μm or less, 2.00 μm or less, 1.50 μm or less, 1.40 μm or less, 1.30 μm or less, 1.20 μm or less, or 1.10 μm or less, or 1.00 μm or less.

The flakes of the printable medium of the present invention may have a length of from 0.20 μm to 2.50 μm, 0.30 μm to 2.50 μm, 0.40 μm to 2.00 μm or 0.1 μm to 1 μm, typically 0.50 μm to 1.50 μm, preferably 0.60 μm to 1.40 μm, more preferably 0.70 μm to 1.30 μm, still more preferably 0.80 μm to 1.20 μm, most preferably 0.90 μm to 1.10 μm.

The flakes of the printable medium of the present invention have a thickness of 0.8 nm or more, such as for example 1 nm or more, 10 nm or more, 20 nm or more, 30 nm or more, 40 nm or more, 50 nm or more, 60 nm or more, 70 nm or more, 80 nm or more, 90 nm or more, or 100 nm or more.

The flakes of the printable medium of the present invention have a thickness of 200 nm or less, such as for example 190 nm or less, 180 nm or less, 170 nm or less, 160 nm or less, 150 nm or less, 140 nm or less, 130 nm or less, 120 nm or less, or 110 nm or less.

The flakes of the printable medium of the present invention may have a thickness of from 20 nm to 180 nm, 30 nm to 160 nm, 40 nm to 140 nm, or 10 nm to 100 nm, typically 50 nm to 150 nm, preferably 60 nm to 140 nm, more preferably 70 nm to 130 nm, still more preferably 80 nm to 120 nm, most preferably 90 nm to 110 nm.

The flakes of the printable medium of the present invention have an aspect ratio of from 5:1 or more, such as for example 6:1 or more, 7:1 or more, 8:1 or more, 9:1 or more, or 10:1 or more.

The flakes of the printable medium of the present invention have an aspect ratio of from 3750:1 or less, such as for example 3000:1 or less, 1000:1 or less, 300:1 or less, 250:1 or less, 200:1 or less, 150:1 or less, 100:1 or less, 50:1 or less, 30:1 or less, 22:1 or less, 18:1 or less, 15:1 or less, or 12:1 or less.

The flakes of the printable medium of the present invention may have an aspect ratio of from 6:1 to 3750:1, 7:1 to 3750:1, 8:1 to 3750:1, 9:1 to 3750:1, 10:1 to 3750:1, 6:1 to 300:1, 7:1 to 300:1, 8:1 to 300:1, 9:1 to 300:1, 10:1 to 300:1, 5:1 to 250:1, 5:1 to 200:1, 5:1 to 150:1, 5:1 to 100:1, 5:1 to 50:1, 5:1 to 50:1, typically 5:1 to 30:1, preferably 6:1 to 22:1, more preferably 7:1 to 18:1, still more preferably 8:1 to 15:1, most preferably 9:1 to 12:1.

In some embodiments the have a length of from 0.1 μm to 3 μm, a thickness of 10 nm to 100 nm, and an aspect ratio of from 5:1 to 300:1. In a typical embodiment, the flakes of the printable medium of the present invention have a length of 0.50 μm to 1.50 μm, a thickness of 50 nm to 150 nm, and an aspect ratio of 5:1 to 30:1. In a preferred embodiment, the flakes of the printable medium of the present invention have a length of 0.60 μm to 1.40 μm, a thickness of 60 nm to 140 nm, and an aspect ratio of 6:1 to 22:1. In a more preferred embodiment, the flakes of the printable medium of the present invention have a length of 0.70 μm to 1.30 μm, a thickness of 700 nm to 130 nm, and an aspect ratio of 7:1 to 18:1. In a still more preferred embodiment, the flakes of the printable medium of the present invention have a length of 0.80 μm to 1.20 μm, a thickness of 80 nm to 120 nm, and an aspect ratio of 8:1 to 15:1. In a most preferred embodiment, the flakes of the printable medium of the present invention have a length of 0.90 μm to 1.10 μm, a thickness of 90 nm to 110 nm, and an aspect ratio of 9:1 to 12:1.

Flakes having the length, thickness and aspect ratio within the ranges and limits described herein may advantageously be able to rotate in the liquid of the printable medium of the present invention. This ability to rotate may allow a flake to orientate itself during the printing process so that the major dimension of the flake may be substantially parallel to the surface onto which the flake is printed. This orientation may provide good contact between the flakes, and consequently good conductivity in the conductive layer of a printed article. Flakes having the length, thickness and aspect ratio within the ranges and limits described herein may advantageously be able to form a conductive layer in a printed article which is sufficiently thin to be capable of flexing without creating discontinuities (e.g. cracks) in the conductive layer.

As used herein, when a material or element is described as conductive, it may refer to an electrically and thermally conductive material or element, or a non-electrically conductive but thermally conductive material or element. The conductive materials or elements referred to herein may be electrically and thermally conductive materials or elements. The conductive materials or elements referred to herein may be electrically non-conductive and thermally conductive materials or elements.

The flakes of the printable medium of the present invention comprise silver, graphene, boron nitride (e. g hexagonal boron nitride) or a mixture thereof. Silver and graphene are electrically and thermally conductive materials. Boron nitride (e.g. hexagonal boron nitride) is a non-electrically conductive but thermally conductive material.

Tyically, the flakes of the printable medium of the present invention are conductive flakes (i.e. electrically and thermally conductive flakes, or non-electrically conductive but thermally conductive flakes). Preferably the flakes of the printable medium of the present invention are electrically and thermally conductive flakes. More preferably the flakes of the printable medium of the present invention comprise silver, graphene, or a mixture thereof. When the flakes of the printable medium of the present invention comprise silver, graphene, or a mixture thereof, they may further comprise an oxidation product of silver, graphene, or a mixture thereof. For example, when the flakes of the printable medium of the present invention comprise silver, they may further comprise silver oxide. Oxidation products of silver, graphene, or a mixture thereof may for example be present on the surface of the flakes, for example as a result of oxidation of the silver, graphene, or a mixture thereof.

The flakes typically do not comprise a capping agent or coating agent. The absence of a capping or coating agent in the flakes of the printable medium of the present invention may improve conductivity of the conductive layer formed when printed. Thus, the flakes of the printable medium of the present invention may consist of silver, graphene, or a mixture thereof, optionally in combination with an oxidation product of silver, graphene, or a mixture thereof, such as silver oxide.

Flakes having the composition described herein may advantageously be able to form a conductive layer in a printed article.

Flakes suitable for the printable medium of the present invention include commercially available flakes, such as Silver Platelets S0010-NM2 available from Ames Goldsmith.

The printable medium of the present invention comprises a liquid. The liquid may be a single substance or a mixture of substances. Typically, the liquid comprises a carrier fluid and optionally further comprises a binder. More typically the liquid is a mixture of substances. Preferably, the liquid comprises a carrier fluid and a binder.

A carrier fluid is typically an aqueous carrier fluid (e.g. water) or an organic carrier fluid (e.g. an oil such as a mineral oil, synthetic oil or plant-based oil). A skilled person will be able to identify a suitable carrier fluid based on the printing method for which the printable medium of the present invention is intended. Thus, suitable carrier fluids include known carrier fluids such as for example carrier fluids suitable for flexographic printing, carrier fluids suitable for thermal inkjet printing, carrier fluids suitable for gravure printing, carrier fluids suitable for screen printing, and carrier fluids suitable for offset printing. Preferably the carrier fluid is an aqueous carrier fluid (e.g. water).

A skilled person will be able to identify a suitable binder based on the printing method for which the printable medium of the present invention is intended. Thus, suitable binders include known binders such as for example binders suitable for flexographic printing, binders suitable for thermal inkjet printing, binders suitable for gravure printing, binders suitable for screen printing, and binders suitable for offset printing. Typically the binder is an organic fluid such as an alcohol (e.g. a monohydric alcohol or a dihydric alcohol or a polyhydric alcohol). Preferably the binder is a dihydric alcohol such as propylene glycol.

Typically the liquid in the printable medium of the present invention comprises water and an organic fluid. Preferably the liquid in the printable medium of the present invention comprises water and propylene glycol.

The viscosity of the liquid is typically sufficient to enable the printable medium of the present invention to be printed in the printing method for which the printable medium of the present invention is intended.

A skilled person will be able to identify a suitable viscosity based on the printing method for which the printable medium of the present invention is intended. Suitable viscosities of the liquid therefore include viscosities suitable for flexographic printing, viscosities suitable for inkjet printing, viscosities suitable for gravure printing, viscosities suitable for screen printing, and viscosities suitable for offset printing.

Typically, viscosities suitable for flexographic printing are in the range of 0.05-0.5 Pa·s, viscosities suitable for inkjet printing are in the range of 0.001-0.005 Pa·s, viscosities suitable for gravure printing are in the range of 0.05-0.2 Pa·s, viscosities suitable for screen printing are in the range of 1-10 Pa·s, and viscosities suitable for offset printing are in the range of 40-100 Pa·s.

Viscosities referred to herein are typically as measured according to ASTM-D7271 ‘Standard Test Method for Viscoelastic Properties of Paste Ink Using and Oscillatory Rheometer

The liquid in the printable medium of the present invention as described above may futher comprise components to level the ink, and/or may futher comprise components to defoam the ink (e.g. during the printing process). Suitable liquid components to level and defoam the ink include surfactants and defoamers commonly used for those purposes in the art. Suitable surfactants include 2-4-7-9-tetramethyl-5-decyn-4,7-diol and other nonionic surfactants. Non-ionic surfactants such as 2-4-7-9-tetramethyl-5-decyn-4,7-diol reduce the surface tension of the particulate filled ink and in combination with low viscosity of the conductive ink formulation act to reduce reticulation and enhance levelling of the ink on the nanoporous surface. Suitable defoamers include water based emulsions of silicone oils, mineral oils, vegetable oils, long chain fatty alcohols, fatty acid soaps, and fatty acid esters.

The liquid may comprise a pigment. The liquid in the printable medium of the present invention typically does not comprise a pigment.

Liquids suitable for the printable medium of the present invention can be prepared from commercially available products including, for example, products in the HydroTek SD range available from Zeller and Gmelin, such as HydroTek SD Trans White YW-X60001V. Suitable commercially available products can be used as-is, or can be diluted before use, e.g. with the same substance used as the carrier fluid in the liquid.

The viscosity of the printable medium of the present invention (i.e. comprising the liquid and the flakes described herein) is typically greater than the viscosity of the liquid, as the presence of the flakes will tend to increase the viscosity. Thus, when the printable medium of the present invention is intended for flexographic printing, the viscosity of the printable medium is typically in the range of 0.1 to 25 Pa·s, such as for example 1 to 22 Pa·s, 3 to 20 Pa·s, 5 to 18 Pa·s, 8 to 15 Pa·s, 0.1 to 5 Pa·s, 1 to 6 Pa·s, 2 to 7 Pa·s, 3 to 8 Pa·s, 4 to 9 Pa·s, 5 to 10 Pa·s, 6 to 11 Pa·s, 7 to 12 Pa·s, 8 to 13 Pa·s, 9 to 14 Pa·s, 10 to 15 Pa·s, 11 to 16 Pa·s, 12 to 17 Pa·s, 13 to 18 Pa·s, 14 to 19 Pa·s, 15 to 20 Pa·s, 16 to 21 Pa·s, 17 to 22 Pa·s, 18 to 23 Pa·s, 19 to 24 Pa·s or 20 to 25 Pa·s.

When the viscosity of the printable medium of the present invention is with the ranges described herein, the flakes are advantageously able to rotate in the liquid. This ability to rotate may allow a flake to orientate itself during the printing process so that the major dimension of the flake may be substantially parallel to the surface onto which the flake is printed. This orientation may provide good contact between the flakes, and consequently good conductivity in the conductive layer of a printed article, while at the same time maintining an advantageously thin conductive layer. The ranges of viscosity of the printable medium of the present invention described herein may also advantageously allow the flakes to be suspended in the liquid during the methods of preparation and printing of the printable medium of the present invention described elsewhere herein (which methods, as described elsewhere herein, typically involve mechanical agitation of the printable medium of the present invention, such as by mixing and/or continuous circulation).

The printable medium of the present invention may further comprise one or more viscosity modifier(s). Suitable viscosity modifiers include carbon naotubes and graphene, and mixtures thereof. Typically, when the flakes comprise graphene and the printable medium further comprises one or more viscosity modifier(s), the one or more viscosity modifier(s) is not graphene. When the printable medium of the present invention further comprises one or more viscosity modifier(s), the one or more viscosity modifier(s) is typically present in an amount necessary to achieve the desired viscosity of the printable medium.

The printable medium of the present invention may further comprise nanoparticles. The nanoparticles may be conductive nanoparticles. The nanoparticles may comprise silver, as discussed above with reference to the flakes of the printable medium of the present invention. The nanoparticles may further comprise an oxidation product of silver, as also discussed above with reference to the flakes of the printable medium of the present invention. Oxidation products of silver, may for example be present on the surface of the nanoparticles, for example as a result of oxidation of the silver. The nanoparticles typically do not comprise a capping agent or coating agent. The absence of a capping or coating agent in the nanoparticles may improve conductivity of the conductive layer formed when printed. Thus, the nanoparticles may consist of silver optionally in combination with an oxidation product of silver such as silver oxide.

As used herein nanoparticles are particles having a particle size of from 1 nm to 100 nm. As used herein, the diameter of a nanoparticle may refer to the number median (D50) of the diameters of nanoparticles. The number median (D50) of the diameters of nanoparticles can be calculated by imaging nanoparticles in the same way as described above with reference to the flakes of the printable medium of the present invention or with Transmission Electron Microscopy or Atomic Force Microscopy. Nanoparticles may be spherical or non-spherical. In imaging methods of calculating the number median (D50) of the diameters of nanoparticles, the diameter of a non-spherical nanoparticle is taken as the largest diameter of the nanoparticle visible in the image.

The presence of nanoparticles of silver in the printable medium of the present invention may advantageously improve contact between adjacent flakes, and may therefore improve conductivity in the conductive layer of a printed article.

The article of the present invention comprises a conductive layer. The conductive layer is provided on the porous receiving layer of the article. The conductive layer comprises flakes. The flakes in the conductive layer of the article present application are as described elsewhere herein with reference to the flakes of the printable medium of the present invention.

There may be contact between flakes in the conductive layer of the article of the present invention. Contact between flakes in the conductive layer of the article of the present invention may be direct or indirect. Indirect contact between flakes in the conductive layer of the article of the present invention may occur, for example, when flakes are in contact with each other via nanoparticles. Contact between flakes, whether direct or indirect, typically results in a conductive connection between flakes, which may provide conductivity to the conductive layer.

The flakes in the conductive layer may overlap each other. That is, there may be an area of overlap between adjacent flakes in the conductive layer. The flakes in the conductive layer may overlap each other such that there is direct contact between adjacent flakes. The flakes in the conductive layer may overlap each other such that there is direct contact between adjacent flakes in an area of overlap between adjacent flakes.

The conductive layer of the article of the present application may also comprise nanoparticles, for example as described above reference to the nanoparticles which may be present in the printable medium of the present invention

When the conductive layer comprises nanoparticles, one or more nanoparticles may be present in an area of overlap between adjacent flakes. When one or more nanoparticles are present in an area of overlap between adjacent flakes in the conductive layer, there may be indirect contact between adjacent flakes, via the one or more nanoparticles present in the area of overlap between adjacent flakes.

The conductive layer of the article of the present application typically has a thickness low enough for the article to be capable of flexing without causing discontinuities (e.g. cracks) in the conductive layer.

The conductive layer of the article of the present application typically does not extend across the entirety of the receiving layer of the article of the present application. The conductive layer of the article of the present application is typically present on the receiving layer in a pattern or trace as may be desired for the intended use of the article.

The article of the present invention comprises a porous receiving layer. The porous receiving layer is provided on the base layer.

The porous receiving layer has a surface roughness of 500 nm or less. As used herein, surface roughness is arithmetic surface roughness (Ra) and is typically as measured by the method described in ISO 21920-2:2021 (Part 1: Surface and its parameters). Typically, the porous receiving layer has a surface roughness of 200 nm or less. Preferably, the porous receiving layer has a surface roughness of 100 nm or less.

It is desirable that the surface roughness of the porous receiving layer is as low as possible. However the porous receiving layer typically has a surface roughness of 10 nm or more, such as for example 20 or more, 30 nm or more, 40 nm or more, or 50 nm or more.

The ratio of the length of the flakes in the conductive layer to the surface roughness of the porous receiving layer is typically 1:1 or more. The ratio of the length of the flakes in the conductive layer to the surface roughness of the porous receiving layer is preferably 3:1 or more. As surface roughness is desired to be as low as possible, it is desirable that the ratio of length of the flakes in the conductive layer to the surface roughness of the porous receiving layer is as high as possible. However the ratio of length of the flakes in the conductive layer to the surface roughness of the porous receiving layer is typically 10,000:1 or less, such as 5,000:1 or less or 3:000:1 or less; and is preferably 100:1 or less, such as 50:1 or less or 30:1 or less.

The porous receiving layer typically comprises pores. The size of the pores in the porous receiving layer is typically 50% or less of the length of the flakes in the conductive layer. The size of the pores in the porous receiving layer is preferably 30% or less of the length of the flakes in the conductive layer. As used herein the size of the pores in the porous receiving may refer to the number median (D50) of the diameters of the pores in the porous receiving layer. The number median (D50) of the diameters of the pores in the porous receiving layer can be calculated by imaging the porous receiving layer in the same way as described above with reference to the flakes and nanoparticles of the printable medium of the present invention. The pores may be spherical or non-spherical. In imaging methods of calculating the number median (D50) of the diameters of the pores, the diameter of a non-spherical pore is taken as the largest diameter of the pore visible in the image.

The surface roughness, ratio of surface roughness to flake length, and/or pore size of the porous receiving layer as described herein may enable the flakes in the conductive layer to be arranged in a way such as to improve contact between flakes, and improve conductivity of the conductive layer.

The porous receiving layer typically has a porosity of 30% or more, e.g. 40% or more, 50% or more, or 60% or more. The porous receiving layer typically has a porosity of 75% or less.

The porosity of the porous receiving area can be determined through the use of nitrogen adsorption porosimetry and accurate measurement of the nanoporous layer by scanning electron microscopy measurement of ion milled step edges or other accurate method to determine coating thickness of porous materials. As used herein, the porosities of the porous receiving area are typically as measured according to ISO 15901-2:2022 Pore size distribution and porosity of solid materials by mercury porosimetry and gas adsorption—Part 2: Analysis of nanopores by gas adsorption.

When the porosity of the porous receiving layer is as described herein, the porous receiving layer may enable liquid in the printable medium to be wicked away from the flakes into the pores when printable medium is applied to the porous receiving layer. Removal of the liquid from the flakes into the pores of the porous receiving layer in this way may avoid the need for a heat treatment step during formation of the conductive layer. The ability to provide a conductive layer without a heat treatment step may enable low melting point and less heat tolerant materials to be used in the article, such as flexible base materials such as polypropylene.

The porous receiving layer typically has a thickness of from 2 μm to 10 μm, preferably 4 μm to 8 μm, more preferably 5 μm to 7 μm.

The porous receiving layer may comprise any material which provides the requisite surface roughness, pore size, and porosity. Typically the porous receiving layer comprises alumina and/or silica. Preferably the porous receiving layer comprises alumina and/or silica nanoparticles (i.e. alumina and/or silica particles having particle sizes as described above with reference to the nanoparticles of the printable medium of the present invention). Alumina nanoparticles may be referred to as nanoalumina, and silica nanoparticles may be referred to as nanosilica.

The material used as the base layer is not particularly limited. Although base layers suitable for flexographic printing are described below the medium of the intention can be applied to a variety of base layers via a variety of printing techniques known to the skilled person, such as for example flexographic printing, inkjet printing, gravure printing, screen printing, and offset printing.

Base layers suitable for flexographic printing include polypropylene.

Suitable base layers provided with suitable receiving layers are commercially available, such as for example OLMEC Paper available from InnovaArt.

The article of the present invention may be flexible. The article of the present invention may be capable of flexing without discontinuities (e.g. cracks) forming in the conductive layer. For example, the article may be capable of being flexed through 70, 80, or 90 degrees around a radius of 5 mm without discontinuities (e.g. cracks) forming in the conductive layer. Tpyically the article is capable of being flexed through 90 degrees around a radius of 5 mm without discontinuities (e.g. cracks) forming in the conductive layer. It is advantageous to avoid discontinuities (e.g. cracks) forming in the conductive layer because such discontinuities are associated with a significant increase in resistance in the printed article.

The printable medium of the present invention can be prepared by providing flakes as described herein with reference to the printed medium of the present invention, providing a liquid as described herein with reference to the printed medium of the present invention, and mixing the flakes and the liquid.

The mixing can be carried out by any suitable technique. Suitable mixing techniques include for example mixing with a dual asymmetric centrifugal mixing. Mixing is typically continued until the point at which the printable medium is used, e.g. in the method of printing of the present invention, to prevent the flakes from settling out of the liquid.

An article of the present invention can be prepared according to the method of printing of the present invention. The method of printing of the present invention comprises providing a printable medium of the present invention, providing a substrate, and applying the printable medium to the substrate, wherein the substrate comprises a porous receiving layer provided on a base layer, and the porous receiving layer is as defined herein in connection with the article of the present invention.

The printable medium of the present invention can be applied to the substrate by any suitable technique, for example flexographic printing, inkjet printing, gravure printing, screen printing, and offset printing. Flexographic printing is preferred

The printable medium of the present invention can be applied to the substrate using a printing apparatus, for example a flexographic printing apparatus, inkjet printing apparatus, gravure printing apparatus, screen printing apparatus, or offset printing apparatus. A flexographic printing apparatus is preferred.

When applying the printable medium of the present invention to the substrate using a printing apparatus, the printable medium is typically continually stirred and/or continually circulated in the printing apparatus. Continual stirring and/or continual circulation of the printable medium of the present invention may be carried out in the printing apparatus by, for example, using a stirrer (e.g. a magnetic stirrer bar) in a chamber of the printing apparatus in which the printable medium of the present invention may be held prior to application to the substrate, and/or by minimising static regions in the flow path from chamber to print head.

An article of the present invention is described hereinbelow with specific reference to FIG. 2. An article has a base layer (not depicted), a porous receiving layer (4 and 5) and a conductive layer (2 and 3). The edges of the flakes in the conductive layer are seen to be lying flat (1) on the surface of the receiving layer.

The invention is further described below by way of the following non-limiting example.

### EXAMPLE

Ames Goldsmith Nano Platelet Silver flake S0010-NM2 (630 g) is mixed with Zeller & Gmelin Hydrotek Transparent White (118.5 g) and water (63 g). The mixing process removes all particulate agglomerations to create a free flowing silver flexographically printable ink.

The ink is loaded onto a standard flexographic printing press fitter with a 6 VOL anilox metering roller. The nanoalumina or nanosilica coated substrate is fed into the press from a roll. A flexographic printing plate with the desired pattern is mounted onto a 22 inch repeat plate cylinder. Ink is loaded into the ink reservoir. Upon operation ink is wetted onto the anilox roller and the silver ink is transferred from the surface of the wetted anilox to the moving substrate by the flexoplate on the plate cylinder. The ink passes through a forced hot air dryer and infra red lamp to dry the ink to prevent loss of definition and coating the rollers in the press with silver ink. The printed substrate is collected in a roll format ready for transfer to die attach or further print processes. Serpentine track test devices are used to measure the sheet resistance of the printed silver layer using a two probe test with an Ohm meter.

1. A printable medium, comprising:
flakes; and
a liquid;
wherein the flakes comprise silver, graphene, boron nitride, or a mixture thereof, and have a length of from 0.1 μm to 3 μm, a thickness of 0.8 nm to 200 nm, and an aspect ratio of from 5:1 to 3750:1;
and wherein the printable medium has a viscosity in the range of 0.1 to 25 Pa·s.

2. A printable medium according to claim 1, wherein the flakes have a length of from 0.1 μm to 1 μm.

3. A printable medium according to claim 1, wherein the flakes have a thickness of 10 nm to 100 nm

4. A printable medium according to claim 1, wherein the flakes have an aspect ratio of from 10:1 to 300:1.

5. A printable medium according to claim 1, which further comprises conductive nanoparticles.

6. A printable medium according to claim 1, wherein the liquid comprises a carrier fluid and a binder.

7. An article comprising:
a conductive layer;
a porous receiving layer; and
a base layer;
wherein:
the conductive layer is provided on the porous receiving layer;
the porous receiving layer is provided on the base layer;
the conductive layer comprises flakes as defined in claim 1; and
the porous receiving layer has a surface roughness of 500 nm or less.

8. An article according to claim 7, wherein the porous receiving layer has a surface roughness of 200 nm or less.

9. An article according to claim 7, wherein the porous receiving layer has a pore size which is 50% or less of the length of the flakes in the conductive layer.

10. An article according to claim 7, wherein the porous receiving layer has a surface roughness of from 40% to 75%.

11. An article according to claim 7, wherein the porous receiving layer comprises nanoalumina and/or nanosilica.

12. An article according to claim 7, the conductive layer further comprises conductive nanoparticles.

13. An article according to claim 7, wherein the article is flexible.

14. A method of producing a printable medium as defined in claim 1, comprising:
providing flakes as defined in claim 1;
providing a liquid as defined in claim 1; and
mixing the flakes and the liquid.

15. A method according to claim 14, further comprising providing conductive nanoparticles, and mixing the conductive nanoparticles together with the flakes and the liquid.

16. A method of printing comprising:
providing a printable medium as defined in claim 1;
providing a substrate; and
applying the printable medium to the substrate;
wherein the substrate comprises a porous receiving layer provided on a base layer, and the porous receiving layer is as defined in claim 7.

17. A method according to claim 16, wherein the printable medium is applied-to the substrate using a printing apparatus.

18. A method according to claim 17 wherein the printing apparatus is a flexographic printing apparatus.
